(19) United States
(12) Patent Application Publication
(10) Pub. No.: US 2025/0063012 A1
(43) Pub. Date: Feb. 20, 2025

(54) CONTENT BASED NOTIFICATION ADAPTATION

(71) Applicant: International Business Machines Corporation, Armonk, NY (US)

(72) Inventors: Swaminathan Balasubramanian, Troy, MI (US); Renganathan Sundararaman, Cary, NC (US); Rajiv Joshi, Yorktown Heights, NY (US); Pierre C. Berlandier, San Diego, CA (US)

(73) Assignee: International Business Machines Corporation, Armonk, NY (US)

(21) Appl. No.: 18/234,166

(22) Filed: Aug. 15, 2023

(51) Int. Cl. H04L 51/224; G06F 16/955; G06F 40/30

(52) U.S. Cl. CPC H04L 51/224; G06F 16/955; G06F 40/30

(57) ABSTRACT

An embodiment intercepts a notification including a portion of natural language text and a Uniform Resource Locator (URL). An embodiment identifies, using a natural language understanding model, a topic of the notification. An embodiment tags, using a content summarization model, a content located at the URL, the tagging comprising assigning a set of content tags to the content, the set of content tags comprising a predefined tag representing the content. An embodiment calculates a relevancy score scoring a comparison between the set of content tags and a set of user tags, the set of user tags comprising a predefined tag representing a profile of an intended recipient of the notification. An embodiment generates, responsive to the relevancy score being above a threshold, using the topic and the set of content tags, a customized notification, the customized notification replacing the notification.

### BACKGROUND

The present invention relates generally to user notification management. More particularly, the present invention relates to a method, system, and computer program for content based notification adaptation.

User-facing notifications, user notifications, or simply notifications, communicate information to users, who might be users of a software application, users with accounts in a system or website, users who have subscribed to notifications, or users whose contact information has been added to a database or distribution list. No particular application need be currently executing on a user's computer or device. For example, a sports application might notify a user that their favorite team has scored, a news site might notify a user of breaking news, a weather application or telecommunications provider might notify a user of an incoming snowstorm or tornado, a messaging application might notify a user of a new message, a cybersecurity implementation might notify members of a response team that an intrusion has been detected, or a content-watching application might notify a user of upcoming new releases.

Because notifications are typically brief, and often have size limits in particular operating system implementations, notifications often include a portion of natural language text and a Uniform Resource Locator (URL). The URL is often in a shortened form as well. The URL typically points to a location at which the user can receive more detail about the notification. For example, a content-watching application's notification might be, “Five new movies coming Friday!See http://sampleURL for more detail.” As another example, a weather notification might be, “Tropical storm Zelda just upgraded to a hurricane, see http://sampleURL2 for more.”

### SUMMARY

The illustrative embodiments provide for content based notification adaptation. An embodiment includes intercepting a notification, the notification comprising a portion of natural language text and a Uniform Resource Locator (URL). An embodiment includes identifying, using a natural language understanding model, a topic of the notification, the topic expressed by the portion of natural language text. An embodiment includes tagging, using a content summarization model, a content located at the URL, the tagging comprising assigning a set of content tags to the content, the set of content tags comprising a predefined tag representing the content. An embodiment includes calculating a relevancy score, the relevancy score scoring a comparison between the set of content tags and a set of user tags, the set of user tags comprising a predefined tag representing a profile of an intended recipient of the notification. An embodiment includes generating, responsive to the relevancy score being above a threshold, using the topic and the set of content tags, a customized notification, the customized notification replacing the notification. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for loading of process software in accordance with an illustrative embodiment;

FIG. 3 depicts a block diagram of an example configuration for content based notification adaptation in accordance with an illustrative embodiment;

FIG. 4 depicts an example of content based notification adaptation in accordance with an illustrative embodiment;

FIG. 5 depicts a continued example of content based notification adaptation in accordance with an illustrative embodiment;

FIG. 6 depicts a continued example of content based notification adaptation in accordance with an illustrative embodiment;

FIG. 7 depicts a continued example of content based notification adaptation in accordance with an illustrative embodiment; and

FIG. 8 depicts a flowchart of an example process for content based notification adaptation in accordance with an illustrative embodiment.

### DETAILED DESCRIPTION

The illustrative embodiments recognize that, as sources of notifications have proliferated, users can become overwhelmed with notifications. Operating system implementations have attempted to alleviate this problem by implementing notification priorities (e.g., priority 1 notifications are delivered as received, while priority 2 or 3 notifications might be delivered later or suppressed), or treating time-sensitive notifications differently from notifications that are not labelled as time-sensitive. However, not all notification sources label their notifications in a way these operating system implementations can make use of, or always set their notifications to the highest priority. In addition, notification controls can be scattered among operating system-specific settings, application-specific settings, and settings over which a user might have no control at all. As well, users might use multiple devices or computer systems, and thus users must navigate different device notification settings for their different devices, attempt to control each notification at its source, or receive redundant notifications on their different devices. Also, because notifications are typically brief, a user might have no way to determine whether the notification concerns something the user is interested in until the user has actually opened an application to which a notification refers or selected a URL included in a notification. Thus, the illustrative embodiments recognize that there is a need for improved user notifications, based on content associated with a notification and a user's known interests, and implementing a central point of notification control for all of a user's devices and computer systems.

The present disclosure addresses the deficiencies described above by providing a process (as well as a system, method, machine-readable medium, etc.) that intercepts a notification to a user, identifies a topic expressed by natural language text in the notification, applies one or more content tags to the notification, calculates a relevancy score of the notification, and generates a customized notification or suppresses the notification depending on the relevancy score. Thus, the illustrative embodiments provide for content based notification adaptation.

An illustrative embodiment configures and manages a user profile for a user of an embodiment. In an embodiment, the user profile includes data the user has provided on the user's notification preferences (e.g., style of notification, how often or how quickly a particular type of notification should be delivered, types and subjects of notifications a user prefers to see or not see, and the like). For example, one user might have specified that notifications for tornado warnings and his favorite sports team be delivered immediately, but notifications of his account name being referenced by users of a social media platform are to be batched into one notification per day. Another embodiment collects user profile data, on an opt-in basis, as a user reacts to notifications. For example, if a user ignores all notifications relating to social media, but reacts immediately to all weather-related notifications, an embodiment might conclude that the user is interested in weather-related notifications but not social-media related notifications. In an embodiment, the user profile includes account information (e.g., the user's username and password) for a notification source, to be used to allow an embodiment to consult data referenced by a notification. For example, a user might have registered to be notified whenever a new paper is added to a password-protected repository of scientific papers, and thus an embodiment would require the user's account information to access the new paper.

An embodiment uses a presently available technique to assign one or more predefined user tags to the user's profile. The set of user tags represents a profile of an intended recipient of a notification. For example, user tags for a user interested in weather-related notifications might include tornado, hurricane, thunderstorm, and freezing-rain. Another embodiment stores a timestamp associated with each user tag. Storing a timestamp allows an embodiment to alter a weight assigned to a user tag, as a particular user tag ages, thus accounting for an evolution in a user's interests over time. Weights assigned to user tags are discussed elsewhere herein.

An embodiment uses a presently available technique to register a notification handler portion of itself to intercept a notification prior to receipt by a user. In some embodiments (e.g., those executing in a system with a centralized notification scheme implemented by a user interface of an operating system), an embodiment registers with the operating system to intercept notifications. In other embodiments (e.g., those executing in a system without a centralized notification scheme, or if the centralized notification scheme is unreliable or inaccessible), an embodiment registers with a notification source, such as an application or website, or uses a user's account information for a notification source to adjust a notification-related setting in the user's profile on that notification source. Other techniques to register to intercept a notification are also possible and contemplated within the scope of the illustrative embodiments.

An embodiment intercepts a notification prior to the notification reaching a user. The notification includes a portion of natural language text and, optionally, a URL. In one embodiment, the notification includes audio, still image, or video content that an embodiment uses a presently available speech-to-text or image-to-text technique to convert to a corresponding portion of natural language text and optionally, a URL. To perform the interception, an embodiment uses a presently available technique, such as registering with an operating system or a notification source to receive notifications.

An embodiment uses a presently available natural language understanding model and a presently available topic extraction technique to identify a topic of the notification, as expressed by the portion of natural language text, a URL included in the notification, or both. For example, one notification, from a content-watching application, might be, “Check out the new releases coming this Friday!See http://sampleURL for more detail.” Thus, an embodiment might identify a topic of the notification as “releases” or “new releases”.

An embodiment uses a presently available natural language understanding model and a presently available technique to identify a tone and general disposition of the notification, as expressed by the portion of natural language text, a URL included in the notification, or both. General disposition refers to an intent or purpose of the notification, for example, as information, apology, motivation, an order, and the like. Some non-limiting examples of a notification's tone are friendly, formal, and serious.

An embodiment accesses a content located at the URL in the notification (using the user's account information if necessary), and uses a presently available content summarization model to tag the content. Tagging includes assigning at least one predefined content tag to the content. The predefined content tag is one of a set of predefined content tags that, when applied, represent at least a portion of the content located at the URL. An embodiment also uses a notification's topic, tone, and general disposition when tagging content. For example, a notification from a content-watching application in April such as “Spring into brand new shows . . . ” might be tagged as uplifting or joyful. In October, a notification like “Halloween is near, time for spooky shows . . . ” might be tagged as thriller or horror.

One embodiment considers a content as a whole when applying tags. Another embodiment divides a content into segments, for example by topic, and applies one or more content tags on a per-segment basis. If the content is divided into segments, the notification referring to that content is also divided into segments, with each notification segment referring to a corresponding content segment. Continuing the content-watching application example, an embodiment accesses the content at http://sampleURL and uses a presently available content summarization model to determine that the content includes two portions, or segments. Segment 1 describes three upcoming Hollywood action movies, including car chases and at least one cliffhanger scene. Thus, the embodiment assigns content tags to segment 1 that include hollywood, movie, action, car-chase, and cliffhanger. Segment 2 describes new episodes of a serial drama involving an extended family, and thus the embodiment assigns content tags to segment 2 that include drama, episodes, and family.

One embodiment uses a user's account information to access a portion of a content located at the URL in the notification, according to the user's authorized access. For example, a repository of scientific papers allows users who have paid for access to view all of a scientific paper, but users who have not paid for access are allowed to see only the title and abstract of the same paper. Thus, if the user being notified has paid, the embodiment accesses the entire paper, and if the user has not paid, the embodiment accesses only the title and abstract. The embodiment uses a presently available content summarization model to tag the content accessible to the embodiment.

An embodiment calculates a relevancy score. The relevancy score scores a comparison between the set of content tags (representing a notification, or an individual segment of a notification) and a set of user tags (representing a profile of an intended recipient of the same notification). One embodiment uses, as the relevancy score, a Jaccard score (also known as a Jaccard index or Jaccard similarity coefficient). A Jaccard score is a presently available measure of the similarity between two sets, defined as the ratio of the size of the intersection of two sets to the size of the union of the two sets. Thus, an embodiment calculates a relevancy score by computing the ratio of the size of the intersection of the set of content tags and the set of user tags to the size of the union of the set of content tags and the set of user tags. Another embodiment calculates a relevancy score by computing a weighted ratio of the size of the intersection of the set of content tags and the set of user tags to the size of the union of the set of content tags and the set of user tags, with the weight set according to a source of the notification. For example, a notification from a weather warning source might have a higher weight than a notification from a content-watching source. Note that a source of the notification might also be a specific account or user. For example, a notification from a user in the notification recipient's “friends” list on a social media platform might have a higher weight than a notification from an account a telecommunications provider has labelled as “spam risk”.

Another embodiment computes a sum of weighted ratios of the size of the intersection of the set of content tags and the set of user tags to the size of the union of the set of content tags and the set of user tags, where each set of user tags represents the user's profile during a particular timespan and each weight corresponds to the same time span as the set of user tags. In one embodiment, the weight corresponding to a current or most recent time span is highest, and weights corresponding to successively older time spans are reduced linearly, according to an exponential decay function, or using another presently available decay scheme. In another embodiment, the weight corresponding to a current or most recent time span is set according to a source of the notification. Other relevancy score computations are also possible and contemplated within the scope of the illustrative embodiments.

If the relevancy score is above a threshold score, an embodiment assumes that the notification, or a segment of the notification, is something the user is likely to be interested in seeing. Thus, an embodiment uses a topic of the notification, the set of content tags, and a presently available natural language text generation technique to generate a customized notification that replaces the original, intercepted notification to the user. If the notification is divided into segments, an embodiment uses a topic of the notification (or segment), the set of content tags referring to that segment, and a presently available natural language text generation technique to generate a customized notification that replaces the original, intercepted notification to the user. In particular, the customized notification includes a summary of the content referenced by the notification (or segment) and its URL (if any), customized to the user's specific interests. If an embodiment (on behalf of a user) is only able to access a portion of the content referenced by the notification and its URL, the customized notification includes a summary of the accessible portion of the content referenced by the notification and its URL, customized to the user's specific interests. Thus, continuing the content-watching application example, because segment 1 has been tagged with content tags including hollywood, movie, action, car-chase, and cliffhanger, and the user's user tags include hollywood, movie, action, car-chase, and blockbluster, an embodiment replaces the original, intercepted notification with a customized notification: “New action movies coming this Friday-Movie1, Movie2, Movie3”. Thus, the customized notification lists the specific movies the user is likely to be interested in, as pulled from the content at the URL in the original notification.

If the relevancy score is equal to or below a threshold score, an embodiment assumes that the notification, or notification segment, is not something the user is likely to be interested in seeing. Thus, an embodiment suppresses the notification from the user. For example, another user might not be interested in watching content, and thus an embodiment does not pass along the original, intercepted notification regarding new content releases to this user.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

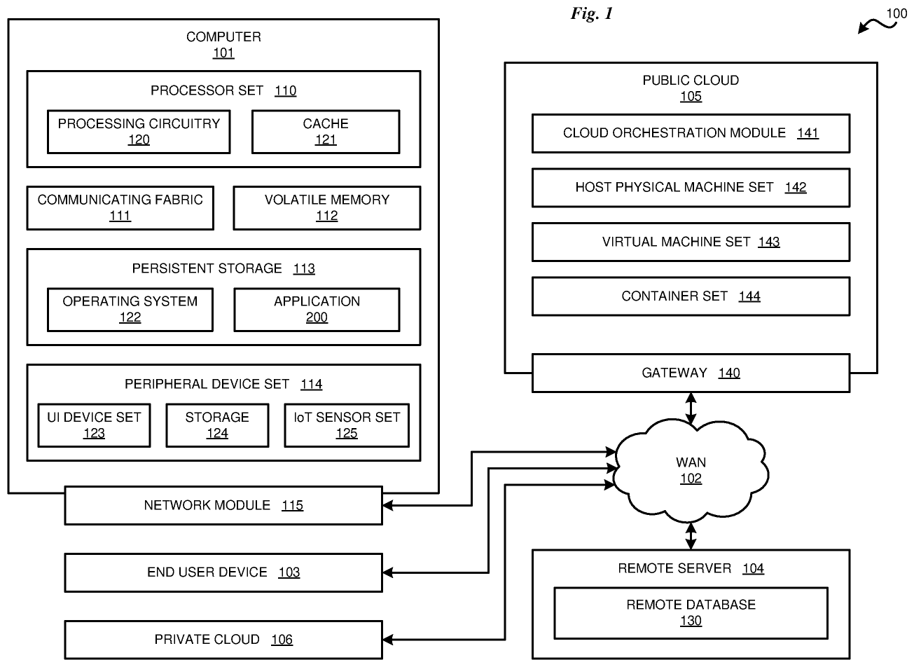

With reference to FIG. 1, this figure depicts a block diagram of a computing environment 100. Computing environment 100 contains an example of an environment for the execution of at least some of the computer code involved in performing the inventive methods, such as an improved application 200 that provides content based notification adaptation. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

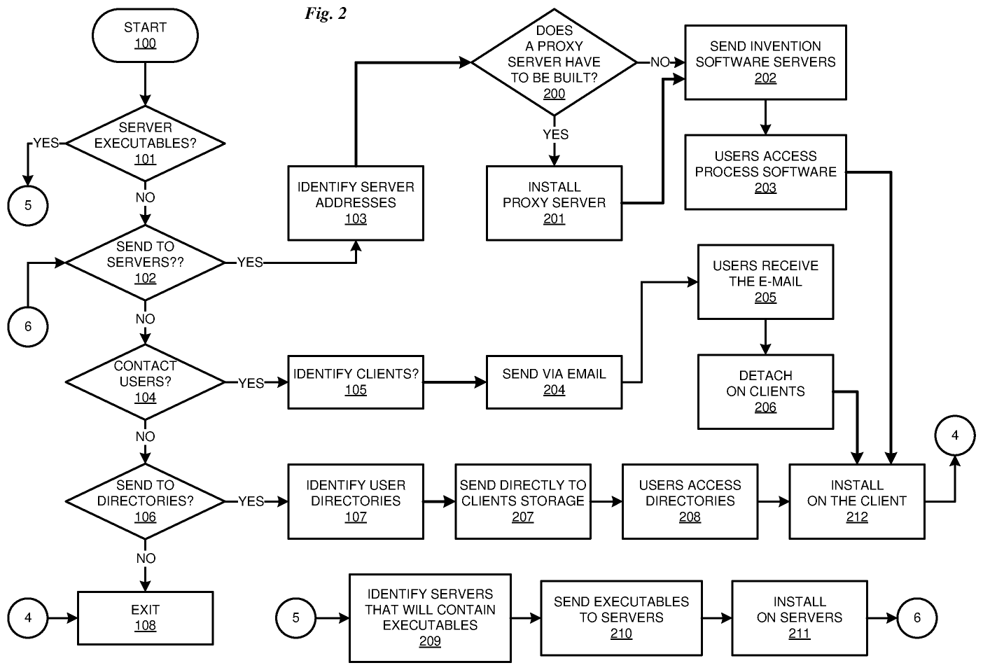

With reference to FIG. 2, this figure depicts a flowchart of an example process for loading of process software in accordance with an illustrative embodiment. The flowchart can be executed by a device such as computer 101, end user device 103, remote server 104, or a device in private cloud 106 or public cloud 105 in FIG. 1.

While it is understood that the process software implementing content based notification adaptation may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 202 begins the deployment of the process software. An initial step is to determine if there are any programs that will reside on a server or servers when the process software is executed (203). If this is the case, then the servers that will contain the executables are identified (229). The process software for the server or servers is transferred directly to the servers' storage via FTP or some other protocol or by copying though the use of a shared file system (230). The process software is then installed on the servers (231).

Next, a determination is made on whether the process software is to be deployed by having users access the process software on a server or servers (204). If the users are to access the process software on servers, then the server addresses that will store the process software are identified (205).

A determination is made if a proxy server is to be built (220) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (221). The process software is sent to the (one or more) servers either via a protocol such as FTP, or it is copied directly from the source files to the server files via file sharing (222). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (223). Another embodiment is to have the servers automatically copy the process software to each client and then run the installation program for the process software at each client computer. The user executes the program that installs the process software on his client computer (232) and then exits the process (210).

In step 206 a determination is made whether the process software is to be deployed by sending the process software to users via e-mail. The set of users where the process software will be deployed are identified together with the addresses of the user client computers (207). The process software is sent via e-mail to each of the users' client computers (224). The users then receive the e-mail (225) and then detach the process software from the e-mail to a directory on their client computers (226). The user executes the program that installs the process software on his client computer (232) and then exits the process (210).

Lastly, a determination is made on whether the process software will be sent directly to user directories on their client computers (208). If so, the user directories are identified (209). The process software is transferred directly to the user's client computer directory (227). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (228). The user executes the program that installs the process software on his client computer (232) and then exits the process (210).

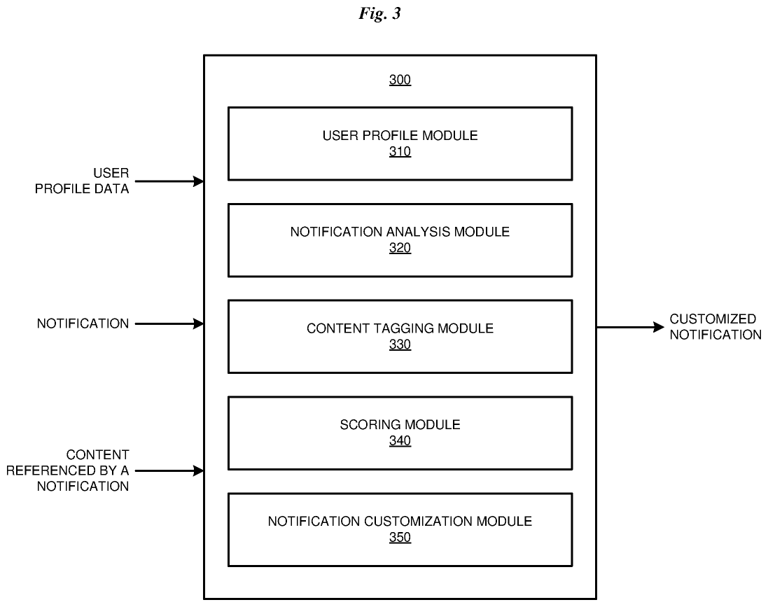

With reference to FIG. 3, this figure depicts a block diagram of an example configuration for content based notification adaptation in accordance with an illustrative embodiment. Application 300 is the same as application 200 in FIG. 1.

In the illustrated embodiment, user profile module 310 configures and manages a user profile for a user. In an implementation of module 310, the user profile includes data the user has provided on the user's notification preferences (e.g., style of notification, how often or how quickly a particular type of notification should be delivered, types and subjects of notifications a user prefers to see or not see, and the like). For example, one user might have specified that notifications for tornado warnings and his favorite sports team be delivered immediately, but notifications of his account name being referenced by users of a social media platform are to be batched into one notification per day. Another implementation of module 310 collects user profile data, on an opt-in basis, as a user reacts to notifications. For example, if a user ignores all notifications relating to social media, but reacts immediately to all weather-related notifications, an embodiment might conclude that the user is interested in weather-related notifications but not social-media related notifications. In an implementation of module 310, the user profile includes account information (e.g., the user's username and password) for a notification source, to be used to allow application 300 to consult data referenced by a notification. For example, a user might have registered to be notified whenever a new paper is added to a password-protected repository of scientific papers, and thus application 300 would require the user's account information to access the new paper.

Module 310 uses a presently available technique to assign one or more predefined user tags to the user's profile. The set of user tags represents a profile of an intended recipient of a notification. For example, user tags for a user interested in weather-related notifications might include tornado, hurricane, thunderstorm, and freezing-rain. Another implementation of module 310 stores a timestamp associated with each user tag. Storing a timestamp allows application 300 to alter a weight assigned to a user tag, as a particular user tag ages, thus accounting for an evolution in a user's interests over time. Weights assigned to user tags are discussed elsewhere herein.

Application 300 uses a presently available technique to register a notification handler portion of itself to intercept a notification prior to receipt by a user. In some implementations (e.g., those executing in a system with a centralized notification scheme implemented by a user interface of an operating system), application 300 registers with the operating system to intercept notifications. In other implementations (e.g., those executing in a system without a centralized notification scheme, or if the centralized notification scheme is unreliable or inaccessible), application 300 registers with a notification source, such as an application or website, or uses a user's account information for a notification source to adjust a notification-related setting in the user's profile on that notification source. Other techniques to register to intercept a notification are also possible.

Notification analysis module 320 intercepts a notification prior to the notification reaching a user. The notification includes a portion of natural language text and, optionally, a URL. In one implementation of module 320, the notification includes audio, still image, or video content that module 320 uses a presently available speech-to-text or image-to-text technique to convert to a corresponding portion of natural language text and optionally, a URL. To perform the interception, module 320 uses a presently available technique, such as registering with an operating system or a notification source to receive notifications.

Module 320 uses a presently available natural language understanding model and a presently available topic extraction technique to identify a topic of the notification, as expressed by the portion of natural language text, a URL included in the notification, or both. For example, one notification, from a content-watching application, might be, “Check out the new releases coming this Friday!See http://sampleURL for more detail.” Thus, module 320 might identify a topic of the notification as “releases” or “new releases”.

Module 320 uses a presently available natural language understanding model and a presently available technique to identify a tone and general disposition of the notification, as expressed by the portion of natural language text, a URL included in the notification, or both.

Content tagging module 330 accesses a content located at the URL in the notification (using the user's account information if necessary), and uses a presently available content summarization model to tag the content. Tagging includes assigning at least one predefined content tag to the content. The predefined content tag is one of a set of predefined content tags that, when applied, represent at least a portion of the content located at the URL. Module 330 also uses a notification's topic, tone, and general disposition when tagging content. For example, a notification from a content-watching application in April such as “Spring into brand new shows . . . ” might be tagged as uplifting or joyful. In October, a notification like “Halloween is near, time for spooky shows . . . ” might be tagged as thriller or horror.

One implementation of module 330 considers a content as a whole when applying tags. Another implementation of module 330 divides a content into segments, for example by topic, and applies one or more content tags on a per-segment basis. Continuing the content-watching application example, module 330 accesses the content at http://sampleURL and uses a presently available content summarization model to determine that the content includes two portions, or segments. Segment 1 describes three upcoming Hollywood action movies, including car chases and at least one cliffhanger scene. Thus, module 330 assigns content tags to segment 1 that include hollywood, movie, action, car-chase, and cliffhanger. Segment 2 describes new episodes of a serial drama involving an extended family, and thus module 330 assigns content tags to segment 2 that include drama, episodes, and family.

One implementation of module 330 uses a user's account information to access a portion of a content located at the URL in the notification, according to the user's authorized access. For example, a repository of scientific papers allows users who have paid for access to view all of a scientific paper, but users who have not paid for access are allowed to see only the title and abstract of the same paper. Thus, if the user being notified has paid, module 330 access the entire paper, and if the user has not paid, module 330 accesses only the title and abstract. Module 330 uses a presently available content summarization model to tag the content accessible to the embodiment.

Scoring module 340 calculates a relevancy score. The relevancy score scores a comparison between the set of content tags (representing a notification, or an individual segment of a notification) and a set of user tags (representing a profile of an intended recipient of the same notification). One implementation of module 340 uses, as the relevancy score, a Jaccard score (also known as a Jaccard index or Jaccard similarity coefficient). In particular, the implementation calculates a relevancy score by computing the ratio of the size of the intersection of the set of content tags and the set of user tags to the size of the union of the set of content tags and the set of user tags. Another implementation of module 340 calculates a relevancy score by computing a weighted ratio of the size of the intersection of the set of content tags and the set of user tags to the size of the union of the set of content tags and the set of user tags, with the weight set according to a source of the notification. For example, a notification from a weather warning source might have a higher weight than a notification from a content-watching source. Note that a source of the notification might also be a specific account or user. For example, a notification from a user in the notification recipient's “friends” list on a social media platform might have a higher weight than a notification from an account a telecommunications provider has labelled as “spam risk”.

Another implementation of module 340 computes a sum of weighted ratios of the size of the intersection of the set of content tags and the set of user tags to the size of the union of the set of content tags and the set of user tags, where each set of user tags represents the user's profile during a particular timespan and each weight corresponds to the same time span as the set of user tags. In one implementation of module 340, the weight corresponding to a current or most recent time span is highest, and weights corresponding to successively older time spans are reduced linearly, according to an exponential decay function, or using another presently available decay scheme. In another implementation of module 340, the weight corresponding to a current or most recent time span is set according to a source of the notification. Other relevancy score computations are also possible.

If the relevancy score is above a threshold score, application 300 assumes that the notification, or a segment of the notification, is something the user is likely to be interested in seeing. Thus, notification customization module 350 uses a topic of the notification, the set of content tags, and a presently available natural language text generation technique to generate a customized notification that replaces the original, intercepted notification to the user. If the notification is divided into segments, module 350 uses a topic of the notification (or segment), the set of content tags referring to that segment, and a presently available natural language text generation technique to generate a customized notification that replaces the original, intercepted notification to the user. In particular, the customized notification includes a summary of the content referenced by the notification (or segment) and its URL (if any), customized to the user's specific interests. If module 330 (on behalf of a user) is only able to access a portion of the content referenced by the notification and its URL, the customized notification includes a summary of the accessible portion of the content referenced by the notification and its URL, customized to the user's specific interests. Thus, continuing the content-watching application example, because segment 1 has been tagged with content tags including hollywood, movie, action, car-chase, and cliffhanger, and the user's user tags include hollywood, movie, action, car-chase, and blockbluster, module 350 replaces the original, intercepted notification with a customized notification: “New action movies coming this Friday-Movie1, Movie2, Movie3”. Thus, the customized notification lists the specific movies the user is likely to be interested in, as pulled from the content at the URL in the original notification.

If the relevancy score is equal to or below a threshold score, application 300 assumes that the notification, or notification segment, is not something the user is likely to be interested in seeing. Thus, application 300 suppresses the notification from the user. For example, another user might not be interested in watching content, and thus an embodiment does not pass along the original, intercepted notification regarding new content releases to this user.

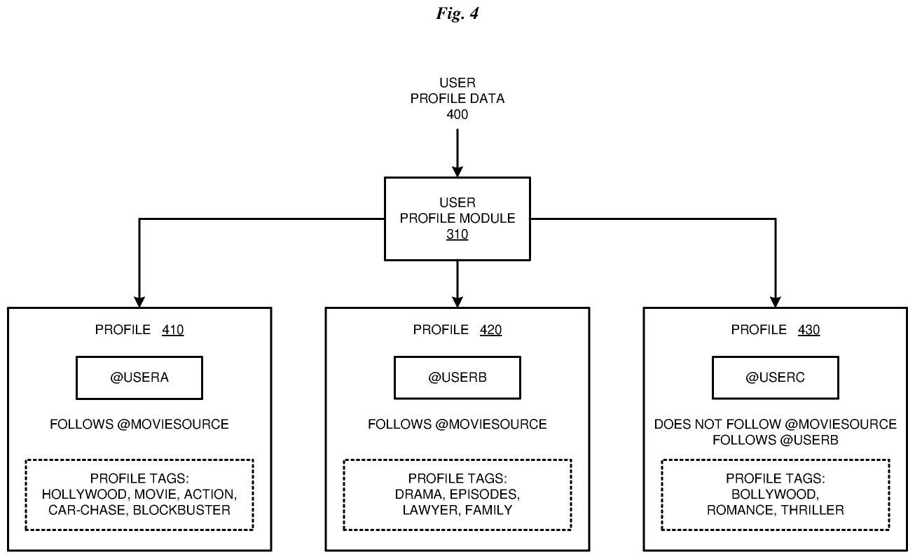

With reference to FIG. 4, this figure depicts an example of content based notification adaptation in accordance with an illustrative embodiment. User profile module 310 is the same as user profile module 310 in FIG. 3. The example can be executed using application 300 in FIG. 3.

As depicted, user profile module 310 has used user profile data 400 to generate user profiles 410, 420, and 430. User profile 410 is a profile of User A, user profile 420 is a profile of User B, and user profile 430 is a profile of User C.

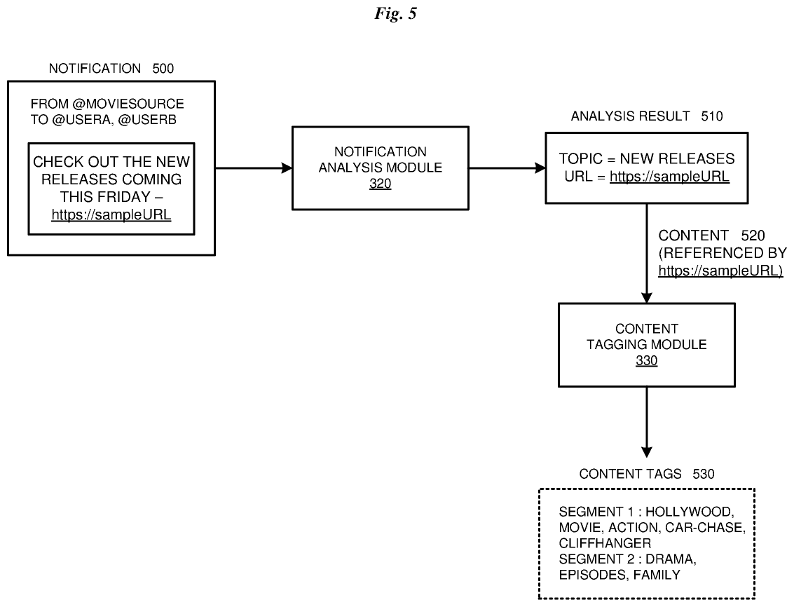

With reference to FIG. 5, this figure depicts a continued example of content based notification adaptation in accordance with an illustrative embodiment. Notification analysis module 320 and content tagging module 330 are the same as notification analysis module 320 and content tagging module 330 in FIG. 3.

As depicted, notification analysis module 320 has intercepted notification 500 prior to notification 500 reaching User A and User B (notification 500's intended recipients). Notification 500 includes a portion of natural language text and a URL. Module 320 uses a presently available natural language understanding model and a presently available topic extraction technique to identify a topic of the notification, as expressed by the portion of natural language text, a URL included in the notification, or both. The results are depicted as analysis result 510.

Content tagging module 330 accesses content 520, a content located at the URL in notification 500 (using the user's account information if necessary), and uses a presently available content summarization model to tag the content. The results are depicted as content tags 530.

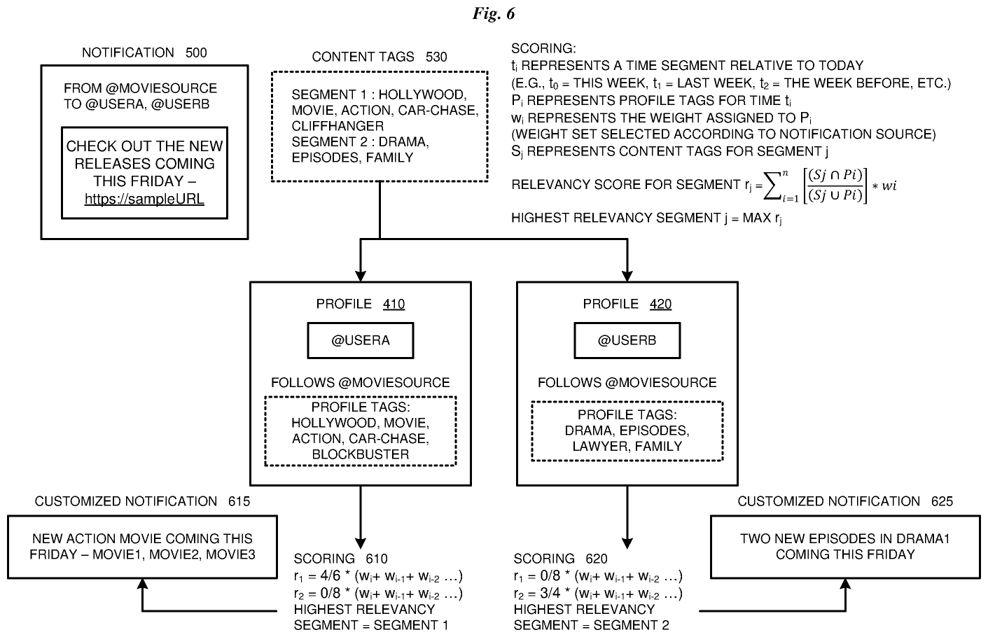

With reference to FIG. 6, this figure depicts a continued example of content based notification adaptation in accordance with an illustrative embodiment. Profiles 410 and 420 are the same as profiles 410 and 420 in FIG. 4. Notification 500 and content tags 530 are the same as notification 500 and content tags 530 in FIG. 5.

As depicted, scoring module 340 has generated scoring 610, comparing profile 410 against content tags 530. Because there are four tags that are the same in segment 1's content tags (in content tags 530) as in profile 410, and 6 tags total, the relevancy score for segment 1 (r₁) in scoring 610 is 4/6 multiplied by the sum of the set of weights. Because there are no tags that are the same in segment 2's content tags (in content tags 530) as in profile 410, and 8 tags total, the relevancy score for segment 2 (r₂) in scoring 610 is zero. The relevancy score for segment 1 is assumed to be above the threshold value, and thus notification customization module 350 generates customized notification 615 that replaces the original, intercepted notification to the user. In particular, customized notification 615 includes a summary of segment 1's content, as this is the portion of the notification that user A is actually interested in.

Scoring module 340 has also generated scoring 620, comparing profile 420 against content tags 530. Because there are no tags that are the same in segment 2's content tags (in content tags 530) as in profile 420, and eight tags total, the relevancy score for segment 2 (r₂) in scoring 620 is zero. Because there are three tags that are the same in segment 2's content tags (in content tags 530) as in profile 420, and four tags total, the relevancy score for segment 2 (r₂) in scoring 620 is ¾ multiplied by the sum of the set of weights. The relevancy score for segment 2 is assumed to be above the threshold value, and thus notification customization module 350 generates customized notification 625 that replaces the original, intercepted notification to the user. In particular, customized notification 625 includes a summary of segment 2's content, as this is the portion of the notification that user B is actually interested in.

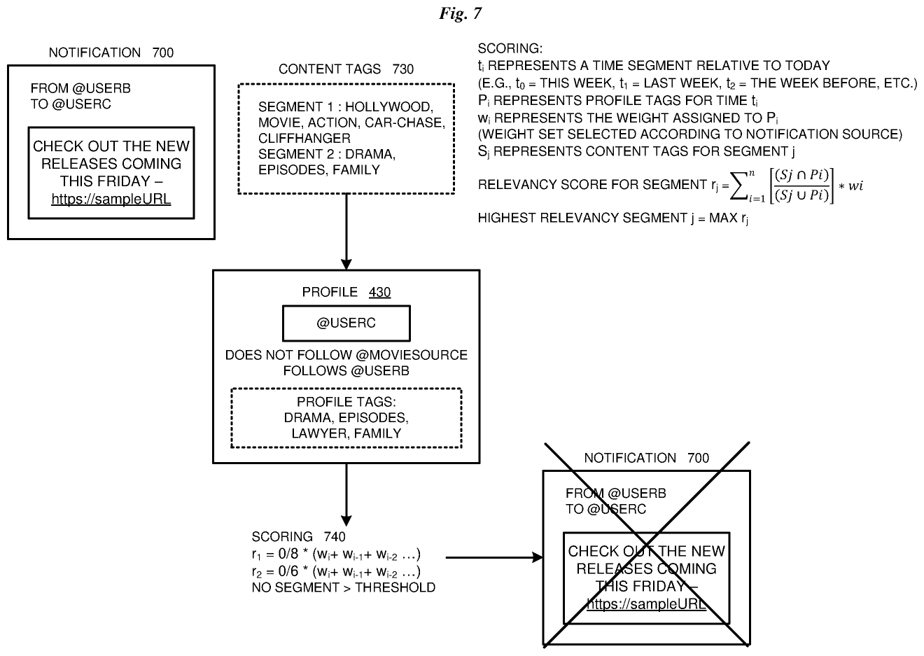

With reference to FIG. 7, this figure depicts a continued example of content based notification adaptation in accordance with an illustrative embodiment. Profile 430 is the same as profiles 430 in FIG. 4.

As depicted, notification analysis module 320 has intercepted notification 700 prior to notification 700 reaching User C. Notification 700 is the same as notification 500, but from User B instead of the original source. Content tagging module 330 accesses content 520, a content located at the URL in notification 700 (using the user's account information if necessary), and uses a presently available content summarization model to tag the content. The results are depicted as content tags 730.

Scoring module 340 has also generated scoring 740, comparing profile 430 against content tags 730. Because there are no tags that are the same in content tags 730 as in profile 430, the relevancy scores for each segment referenced by notification 700 (depicted in scoring 740) are zero. Note that even if there were tags in common, weights affecting the calculations in scoring 740 might have altered from those used in scoring 620, due the source of notification 700 being different from that of notification 500. Thus, application 300 suppressed notification 700.

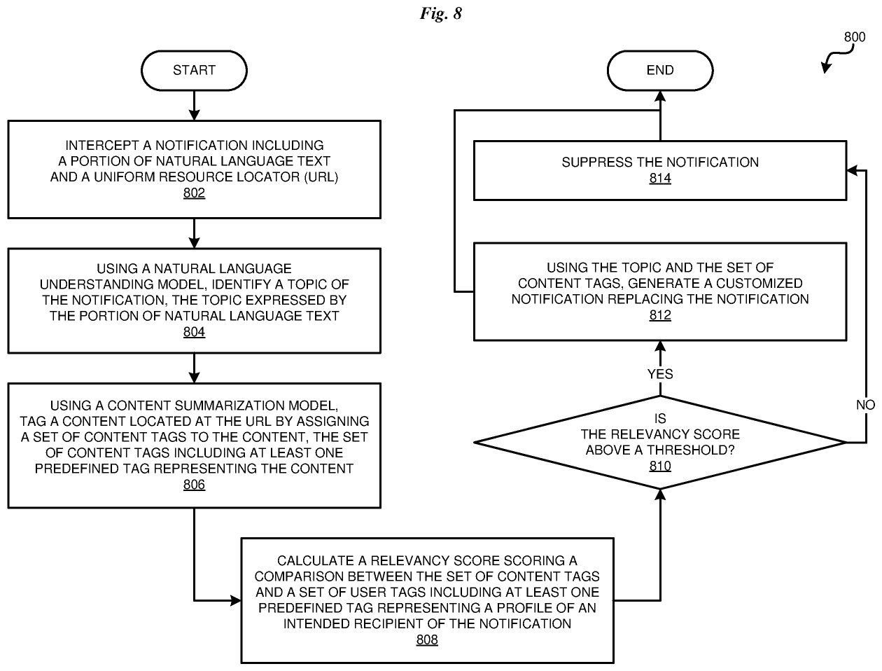

With reference to FIG. 8, this figure depicts a flowchart of an example process for content based notification adaptation in accordance with an illustrative embodiment. Process 800 can be implemented in application 200 in FIG. 3.

In the illustrated embodiment, at block 802, the process intercepts a notification including a portion of natural language text and a URL. At block 804, the process, using a natural language understanding model, identifies a topic of the notification, the topic expressed by the portion of natural language text. At block 806, the process, using a content summarization model, tags a content located at the URL by assigning a set of content tags to the content, the set of content tags including at least one predefined tag representing the content. At block 808, the process calculates a relevancy score scoring a comparison between the set of content tags and a set of user tags including at least one predefined tag representing a profile of an intended recipient of the notification. At block 810, the process determines whether the relevancy score is above a threshold. If yes (“YES” path of block 810), at block 812 the process, using the topic and the set of content tags, generates. a customized notification replacing the notification, then ends. Otherwise, (“NO” path of block 810), at block 814 the process suppresses the notification, then ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
intercepting a notification, the notification comprising a portion of natural language text and a Uniform Resource Locator (URL);
identifying, using a natural language understanding model, a topic of the notification, the topic expressed by the portion of natural language text;
tagging, using a content summarization model, a content located at the URL, the tagging comprising assigning a set of content tags to the content, the set of content tags comprising a predefined tag representing the content;
calculating a relevancy score, the relevancy score scoring a comparison between the set of content tags and a set of user tags, the set of user tags comprising a predefined tag representing a profile of an intended recipient of the notification; and
generating, responsive to the relevancy score being above a threshold, using the topic and the set of content tags, a customized notification, the customized notification replacing the notification.

2. The computer-implemented method of claim 1, further comprising:
suppressing, responsive to the relevancy score being equal to or below the threshold, the notification.

3. The computer-implemented method of claim 1, wherein the relevancy score is computed using a weight, the weight assigned a value according to a source of the notification.

4. The computer-implemented method of claim 1, wherein the predefined tag representing the profile of the intended recipient of the notification comprises a timestamp.

5. The computer-implemented method of claim 1, wherein the relevancy score is computed using a set of weights, each weight in the set of weights corresponding to a successively older timespan, wherein the set of weights is reduced from a starting weight according to a decay function, wherein the starting weight corresponds to a timespan including a current time.

6. The computer-implemented method of claim 5, wherein the starting weight is assigned a value according to a source of the notification.

7. The computer-implemented method of claim 1, wherein the customized notification comprises a summary of a content referenced by the URL.

8. A computer program product comprising one or more computer readable storage media, and program instructions collectively stored on the one or more computer readable storage media, the program instructions executable by a processor to cause the processor to perform operations comprising:
intercepting a notification, the notification comprising a portion of natural language text and a Uniform Resource Locator (URL);
identifying, using a natural language understanding model, a topic of the notification, the topic expressed by the portion of natural language text;
tagging, using a content summarization model, a content located at the URL, the tagging comprising assigning a set of content tags to the content, the set of content tags comprising a predefined tag representing the content;
calculating a relevancy score, the relevancy score scoring a comparison between the set of content tags and a set of user tags, the set of user tags comprising a predefined tag representing a profile of an intended recipient of the notification; and
generating, responsive to the relevancy score being above a threshold, using the topic and the set of content tags, a customized notification, the customized notification replacing the notification.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, further comprising:
suppressing, responsive to the relevancy score being equal to or below the threshold, the notification.

12. The computer program product of claim 8, wherein the relevancy score is computed using a weight, the weight assigned a value according to a source of the notification.

13. The computer program product of claim 8, wherein the predefined tag representing the profile of the intended recipient of the notification comprises a timestamp.

14. The computer program product of claim 8, wherein the relevancy score is computed using a set of weights, each weight in the set of weights corresponding to a successively older timespan, wherein the set of weights is reduced from a starting weight according to a decay function, wherein the starting weight corresponds to a timespan including a current time.

15. The computer program product of claim 14, wherein the starting weight is assigned a value according to a source of the notification.

16. The computer program product of claim 8, wherein the customized notification comprises a summary of a content referenced by the URL.

17. A computer system comprising a processor and one or more computer readable storage media, and program instructions collectively stored on the one or more computer readable storage media, the program instructions executable by the processor to cause the processor to perform operations comprising:
intercepting a notification, the notification comprising a portion of natural language text and a Uniform Resource Locator (URL);
identifying, using a natural language understanding model, a topic of the notification, the topic expressed by the portion of natural language text;
tagging, using a content summarization model, a content located at the URL, the tagging comprising assigning a set of content tags to the content, the set of content tags comprising a predefined tag representing the content;
calculating a relevancy score, the relevancy score scoring a comparison between the set of content tags and a set of user tags, the set of user tags comprising a predefined tag representing a profile of an intended recipient of the notification; and
generating, responsive to the relevancy score being above a threshold, using the topic and the set of content tags, a customized notification, the customized notification replacing the notification.

18. The computer system of claim 17, further comprising:
suppressing, responsive to the relevancy score being equal to or below the threshold, the notification.

19. The computer system of claim 17, wherein the relevancy score is computed using a weight, the weight assigned a value according to a source of the notification.

20. The computer system of claim 17, wherein the predefined tag representing the profile of the intended recipient of the notification comprises a timestamp.
